(19) United States
(12) Patent Application Publication
(10) Pub. No.: US 2025/0004352 A1
(43) Pub. Date: Jan. 2, 2025

(54) OPTICAL ELEMENT DRIVING MECHANISM

(71) Applicant: TDK TAIWAN CORP., Taoyuan City (TW)

(72) Inventors: Chen-Hung CHAO, Taoyuan City (TW); Po-Xiang ZHUANG, Taoyuan City (TW); Yi-Ho CHEN, Taoyuan City (TW); Chao-Chang HU, Taoyuan City (TW); Wei-Jhe SHEN, Taoyuan City (TW); Sin-Jhong SONG, Taoyuan City (TW)

(21) Appl. No.: 18/756,858

(22) Filed: Jun. 27, 2024

Related U.S. Application Data
(60) Provisional application No. 63/510,752, filed on Jun. 28, 2023.

(51) Int. Cl. G03B 5/00

(52) U.S. Cl. CPC G03B 5/00; G03B 2205/0046; G03B 2205/0069

(57) ABSTRACT

An optical element driving mechanism is provided, including a movable part, a first frame, a driving assembly, and a first sensing assembly. The movable part is for connecting an optical element. The movable part may move relative to the first frame. The driving assembly drives the movable part to move relative to the first frame. The first sensing assembly is for sensing the movement of the movable part.

### CROSS REFERENCE TO RELATED APPLICATIONS

This application claims the benefit of U.S. Provisional Application No. 63/510,752, filed 2023 Jun. 28, the entirety of which is incorporated by reference herein.

### BACKGROUND OF THE INVENTION

### Field of the Invention

The present invention relates to an optical element driving mechanism, and in particular, relates to an optical element driving mechanism that drives optical elements to move in two dimensions.

### Description of the Related Art

With the advancement of technology, many electronic devices today such as laptops, smartphones, and digital cameras are equipped with photography or videography capabilities. The widespread use of these electronic devices has led to advancements in optical quality, aiming for stability and improved performance, while also trending towards convenience and lightweight design to offer users more choice.

There is a need for an optical component that allows for the adjustment of optical zoom to meet various photographic needs. However, integrating longer focal length optical elements (such as lenses) into these electronic devices increases their thickness, which is detrimental to the lightweight and stability objectives. Therefore, designing an optical element driving mechanism that enables a reduction in weight and an increase in stability of electronic devices has become an important challenge.

### BRIEF SUMMARY OF THE INVENTION

The term “embodiment” and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate parts of the entire specification of this disclosure, any or all drawings, and each claim.

To address the aforementioned issues, according to certain features of the present disclosure, an optical element driving mechanism is provided. The optical element driving mechanism includes a movable part, a first frame, a driving assembly, and a first sensing assembly. The movable part is for connecting an optical element and may move relative to the first frame. The driving assembly drives the movable part to move relative to the first frame. The first sensing assembly senses the movement of the movable part.

According to certain aspects of the present disclosure, the optical element driving mechanism further includes a second frame and an optical module, wherein the first frame is positioned within the optical module. The optical module includes a mobile part, a fixed part, a driving unit, and a second sensing assembly. The mobile part connects to an optical unit and may move relative to the fixed part. The driving unit drives the mobile part relative to the fixed part. The second sensing assembly senses the movement of the mobile part. The second frame fixedly connects the mobile part. A part of the driving unit is fixedly connected to the first frame. The first frame is fixedly connected to the fixed part. The driving assembly and the driving unit are positioned on opposite sides of the fixed part.

According to certain features of the present disclosure, the driving unit includes a first coil, a magnetic element, and a second coil. The first coil has a first section, a second section, and a third section. The magnetic element has a magnetic element surface facing the first section. The second coil corresponds to the magnetic element and includes a fourth section, a fifth section, and a sixth section. The first section is connected to the third section via the second section. The first section is not parallel to the second section. The third section is not parallel to the second section. When viewed along a direction perpendicular to the magnetic element surface, the magnetic element surface does not overlap with the third section. When viewed along a direction perpendicular to the magnetic element surface, the magnetic element surface does not fully cover the second section. A magnetic pole arrangement direction of the magnetic element passes through the magnetic element surface.

According to certain features of the present disclosure, a first sensing element of the first sensing assembly is disposed between the first coil and the second coil. The first sensing element corresponds to the magnetic element. The first sensing element includes a reference part and a magnetized part. The reference part has a fixed magnetic field direction. The magnetized part may change the magnetic field direction based on the direction of the surrounding magnetic field. The driving assembly drives the movable part to move relative to the first frame in a first dimension. The driving unit drives the movable part and the mobile part to move relative to the fixed part in a second dimension.

According to certain features of the present disclosure, the movable part may move within a movable part movement range relative to the first frame. The movable part movement range is defined by a first extreme position and a second extreme position. When the movable part is in the first extreme position, the angle between the magnetic pole arrangement direction and the fixed magnetic field direction is neither 0 degrees nor 180 degrees. When the movable part is in the second extreme position, the angle between the magnetic pole arrangement direction and the fixed magnetic field direction is neither 0 degrees nor 180 degrees. When the movable part is in any position within the movable part movement range, the angle between the magnetic pole arrangement direction and the fixed magnetic field direction is neither 0 degrees nor 180 degrees.

According to certain features of the present disclosure, a movable part default position is defined within the movable part movement range. The movable part default position is located in the middle of three equal parts of the movable part movement range. When the movable part is in the movable part default position, the angle between the magnetic pole arrangement direction and the fixed magnetic field direction is between 60 degrees and 120 degrees. When the movable part is in the movable part default position, the angle between the magnetic pole arrangement direction and the fixed magnetic field direction is 90 degrees. The mobile part may move relative to the fixed part within a mobile part movement range.

According to certain features of the present disclosure, the optical element driving mechanism further includes a first database, a second database, and a third database. The first database records the relationship between the position of the movable part and a first sensing signal output by the first sensing assembly. The second database records the relationship between the position of the mobile part and a second sensing signal output by the second sensing assembly. The third database records the relationship between the first database and the second database.

According to certain features of the present disclosure, the third database includes the relationship between a plurality of positions within the movable part movement range and the first sensing signal when the mobile part is in a mobile part default position.

According to certain features of the present disclosure, the third database includes the relationship between a plurality of positions within the movable part movement range and the first sensing signal when the mobile part is in a first calibration position. The mobile part default position and the first calibration position are different. The third database includes the relationship between a plurality of positions within the movable part movement range and the first sensing signal when the mobile part is in a second calibration position. The mobile part default position and the second calibration position are different. The first calibration position and the second calibration position are different, and the mobile part default position is between the first calibration position and the second calibration position.

According to certain features of the present disclosure, the optical element driving mechanism further includes a control unit that outputs a control signal based on the first sensing signal, the second sensing signal, the first database, the second database, and the third database to drive the movable part.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a front perspective view of an optical element driving mechanism, according to certain features of the present disclosure.

FIG. 2 is a rear perspective view of the optical element driving mechanism, according to certain features of the present disclosure.

FIG. 3 is a front exploded perspective view of the optical element driving mechanism, according to certain features of the present disclosure.

FIG. 4 is a rear perspective view of the optical element driving mechanism, according to certain features of the present disclosure. For illustrative purposes, the outer frame of the mobile part and the movable part main body of the movable part are not combined, and the first frame is shown in dashed line.

FIG. 5 is a rear perspective view of the driving assembly and the sensing element of the first sensing assembly, according to certain features of the present disclosure.

FIG. 6 is a rear view of the driving assembly and the sensing element of the first sensing assembly, according to certain features of the present disclosure.

FIG. 7 is a rear perspective view of the optical element driving mechanism, according to certain features of the present disclosure, in which the movable part is in a default position, and the upper cover and the first frame are shown in dashed lines for illustrative purposes.

FIG. 8 is a rear perspective view of the optical element driving mechanism, according to certain features of the present disclosure, in which the movable part is in a first extreme position, and the upper cover and the first frame are shown in dashed lines for illustrative purposes.

FIG. 9 is a rear perspective view of the optical element driving mechanism, according to certain features of the present disclosure, in which the movable part is in a second extreme position. For illustrative purposes, the upper cover and the first frame are shown in dashed lines.

FIG. 10 is a diagram showing the relationship between the change in angle between the magnetic pole arrangement direction of the magnetic element and the fixed magnetic field direction of the reference part of the sensing element and the resistance, according to certain features of the present disclosure.

FIG. 11 is a rear perspective view of the optical element driving mechanism, according to certain features of the present disclosure, in which the mobile part is in a default position. For illustrative purposes, elements such as the optical element, the outer frame, the upper cover and first frame are removed, and the bottom case is shown in dashed lines.

FIG. 12 is a rear perspective view of the optical element driving mechanism, according to certain features of the present disclosure, in which the mobile part is in a first calibration position. For illustrative purposes, elements such as the optical element, the outer frame, the upper cover, and the first frame are removed, and the bottom case is shown in dashed lines.

FIG. 13 is a rear perspective view of the optical element driving mechanism, according to certain features of the present disclosure, in which the mobile part is in a second calibration position. For illustrative purposes, elements such as the optical element, the outer frame, the upper cover, and the first frame are removed, and the bottom case is shown in dashed lines.

FIG. 14 is a block diagram of a control unit, a first database, a second database, and a third database of the optical element driving mechanism, according to certain features of the present disclosure.

### DETAILED DESCRIPTION OF THE INVENTION

Various embodiments are described with reference to the attached FIG.s, where like reference numerals are used throughout the FIG.s to designate similar or equivalent elements. The FIG.s are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features may be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, may be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

It is understood that, although terms such as “first,” “second,” etc., may be used herein to describe various components, layers, and/or parts, these terms should not be construed as limiting such components, layers, and/or parts, and are merely for distinguish between different components, layers, and/or parts. Therefore, a first component, layer, and/or part discussed below may be referred to as a second component, layer, and/or part without departing from the teachings of some embodiments disclosed herein. Additionally, for brevity, the terms “first,” “second,” etc., may not be for distinguish between different components in the specification. The first component and/or second component as described in the claims of the application may be interpreted as any component described in the specification.

It should be noted that the technical solutions provided in different embodiments below may be interchanged, combined, or mixed to form another embodiment without departing from the spirit of the disclosure herein.

The present disclosure relates to an optical element driving mechanism that drives a movable part to adjust the photographic imaging of an optical system to meet various photographic needs.

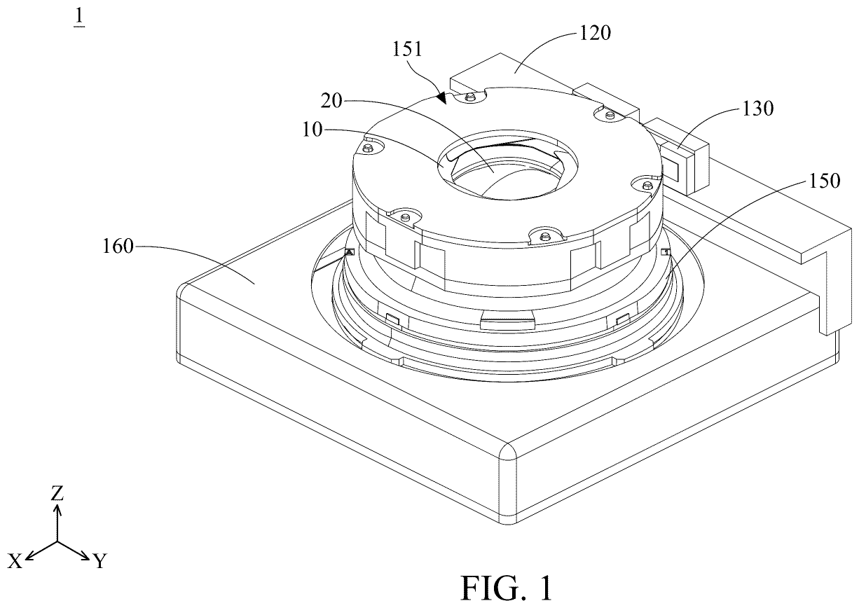

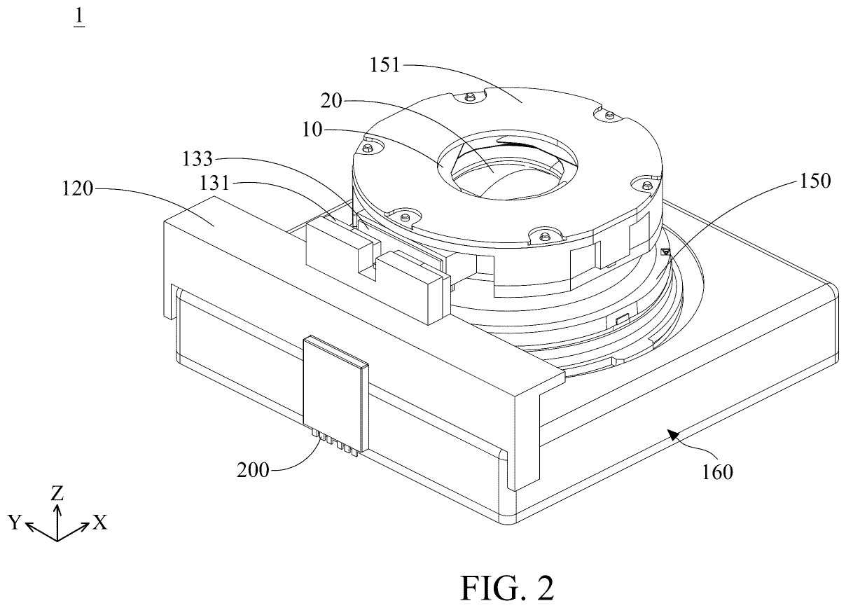

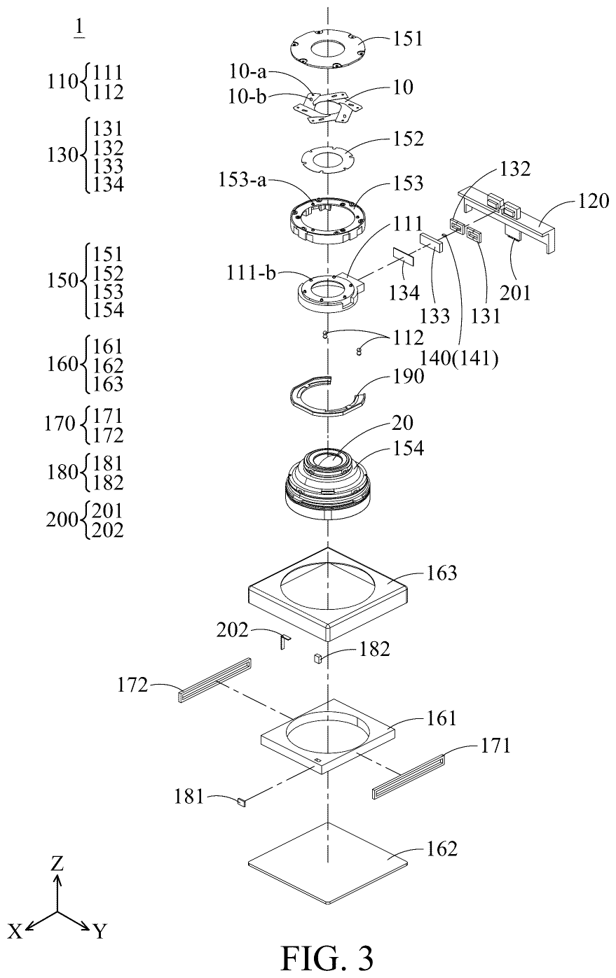

First, please refer to FIG. 1, FIG. 2, and FIG. 3 together. FIG. 1 is a front perspective view of an optical element driving mechanism 1, according to certain features of the present disclosure. FIG. 2 is a rear perspective view of the optical element driving mechanism 1, according to certain features of the present disclosure. FIG. 3 is a front exploded perspective view of the optical element driving mechanism 1, according to certain features of the present disclosure.

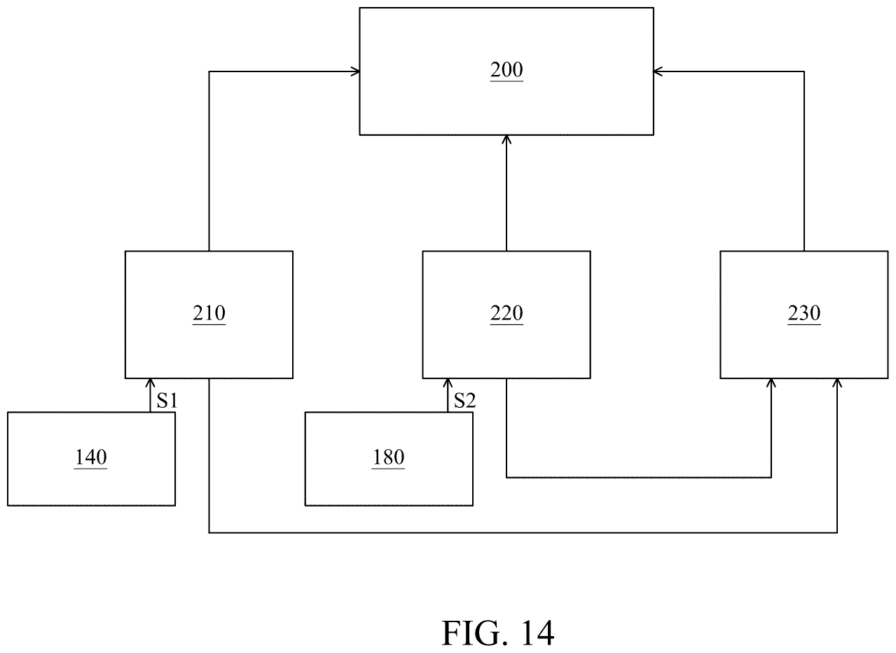

The optical element driving mechanism 1 includes a movable part 110, a first frame 120, a driving assembly 130, a first sensing assembly 140, a mobile part 150, a fixed part 160, a driving unit 170, a second sensing assembly 180, a second frame 190, a control unit 200, a first database 210, a second database 220, and a third database 230 (shown in FIG. 14).

The movable part 110 is for connecting an optical element 10. The optical element 10 may be, for example, a blade, a filter, a lens, a photosensitive element, etc. In this embodiment, the optical element 10 is a blade, and six optical elements 10 form an aperture. Each optical element 10 has a hole 10-a and a long hole 10-b for connecting the movable part 110 and the mobile part 150, as will be further explained below.

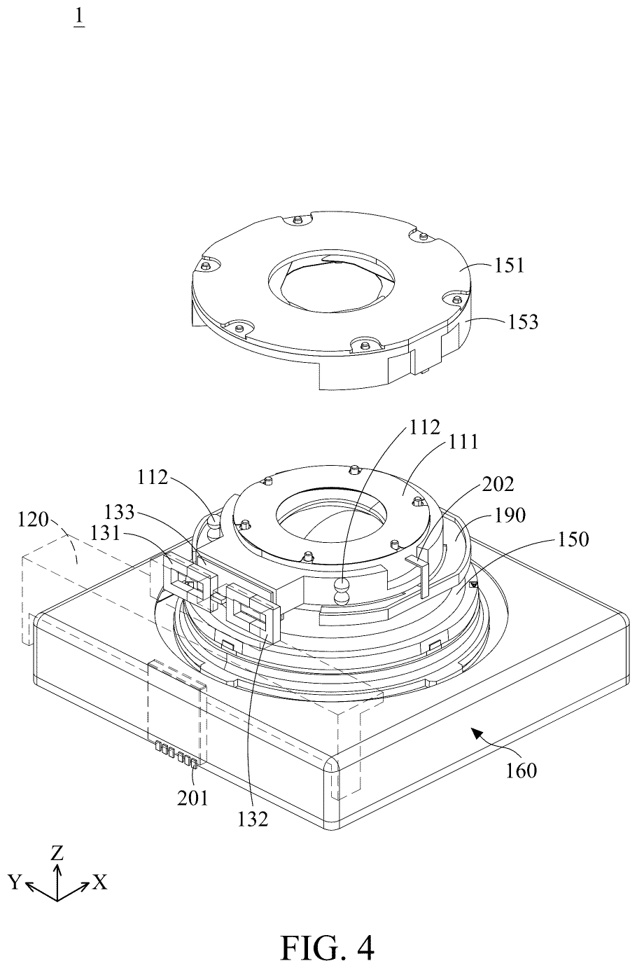

The movable part 110 and the optical element 10 may move relative to the first frame 120. The movable part 110 has a movable part main body 111 and a plurality of connecting elements 112. The connecting element 112 is for movably connecting the movable part 110 and the fixed part 160, as will be further explained below with respect to FIG. 4. The movable part main body 111 has a plurality of protrusions 111-b, which pass into the long hole 10-b of the optical element 10 and may move within the long hole 10-b.

The first frame 120 is disposed on an optical module (not shown, for example, it may be a camera module, etc.), and the first frame 120 is fixedly connected to the fixed part 160.

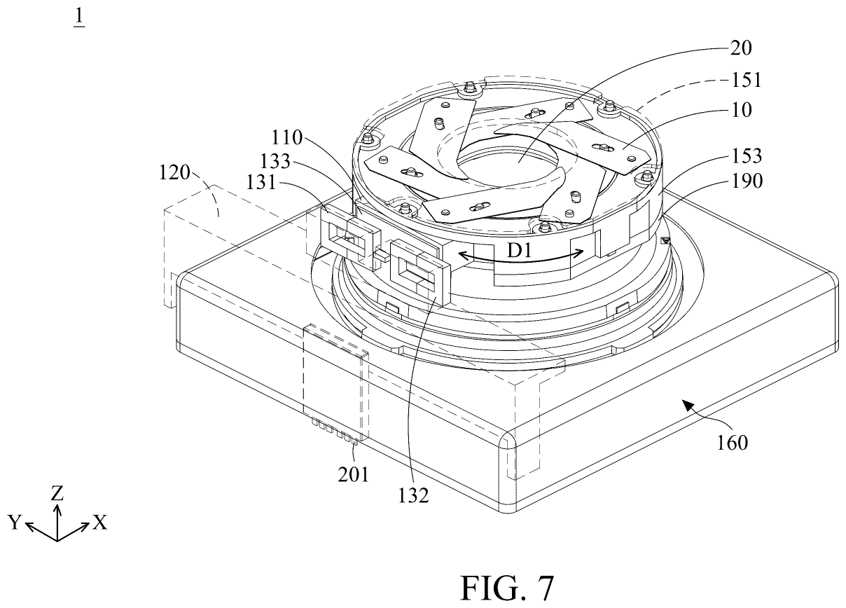

The driving assembly 130 has a first coil 131, a second coil 132, a magnetic element 133, and a magnetic conductive element 134. The driving assembly 130 is for driving the movable part 110 to move relative to the first frame 120, as will be further explained below with reference to FIGS. 7 to 9. Parts of the driving assembly 130, specifically the first coil 131 and the second coil 132, are fixedly connected to the first frame 120. The magnetic conductive element 134 is fixed between the magnetic element 133 and the mobile part 150 to prevent the magnetic field from interfering with the movement of the movable part 110. The first sensing assembly 140 has a first sensing element 141, which is fixedly disposed on the first frame 120 for sensing the movement of the movable part 110.

The mobile part 150 is movably connected to the movable part 110 and the fixed part 160. The mobile part 150 is for connecting an optical unit 20 (e.g., lens). The mobile part 150 may move relative to the fixed part 160. The mobile part 150 includes an upper cover 151, a light-shielding element 152, an outer frame 153, and a carrying part 154. The upper cover 151 is located above the optical element 10. The light-shielding element 152 is located below the optical element 10 and may be made of material such as SOMA to prevent light leakage. The outer frame 153 has a plurality of protrusions 153-a, which pass into the holes 10-a of the optical element 10 and may rotate within the holes 10-a. The second frame 190 is fixedly connected to the mobile part 150 through the carrying part 154, and the second frame 190 may carry the movable part 110 and the outer frame 153.

The plurality of protrusions 111-b of the movable part main body 111 pass into the long hole 10-b of the optical element 10 and move within the long hole 10-b. The plurality of protrusions 153-a of the outer frame 153 pass into the hole 10-a of the element 10 and rotate within the hole 10-a. The optical element 10 is connected to the movable part main body 111 and the outer frame 153.

When the movable part main body 111 is driven by the driving assembly 130 to move, the protrusions 111-b of the movable part main body 111 move in the long hole 10-b, and the protrusions 153-a of the outer frame 153 move in the hole 10-a, thereby driving the movement of the optical element 10. Through the movement of the optical element 10, the aperture size formed by the optical element 10 may be adjusted.

The fixed part 160 includes a base 161, a bottom plate 162, and a bottom case 163. The base 161 and the bottom case 163 are attached to the base plate 162. The bottom case 163 and the bottom plate 162 surround the base 161 and the driving unit 170 to block external impacts. The driving assembly 130 and the driving unit 170 are located on different sides of the fixed part 160.

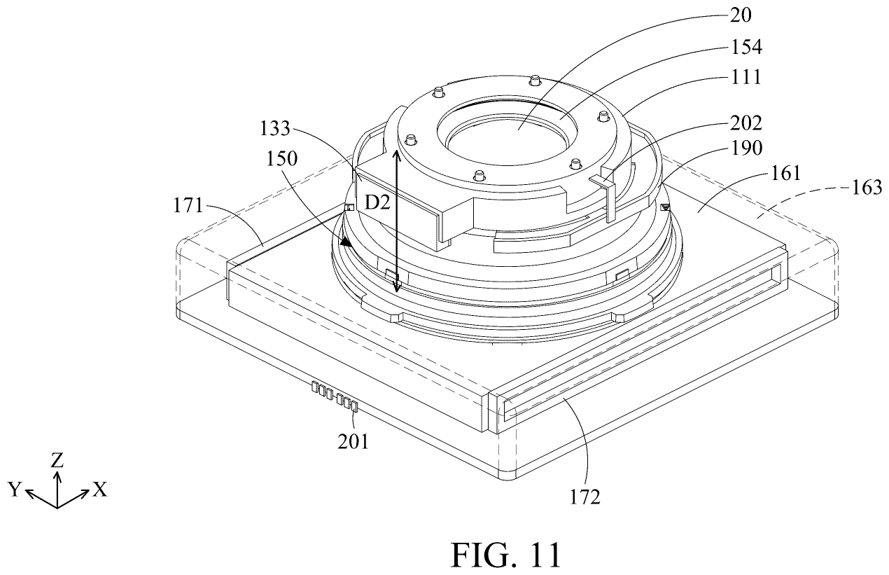

The driving unit 170 is for driving the mobile part 150 to move relative to the fixed part 160. The driving unit 170 includes a coil 171 and a coil 172, which are disposed on both sides of the base 161, and the mobile part 150 is provided with magnetic units (not shown) on the sides corresponding to the coil 171 and the coil 172. Thereby the mobile part 150 and the movable part 110 may be driven to move relative to the first frame 120, as will be further explained below with reference to FIG. 11 to FIG. 13.

The second sensing assembly 180 is for sensing the movement of the mobile part 150. The second sensing assembly 180 includes a second sensing element 181 and a magnet element 182. The second sensing element 181 and the magnet element 182 are both fixed to the base 161 of the fixed part 160.

The control unit 200 includes a control element 201 and a communication element 202. The control element 201 is disposed on the first frame 120 and is for outputting a control signal to the driving assembly 130 to drive the movable part 110. The communication element 202 is located between the mobile part 150 and the movable part 110 and is for transmitting control signal to the driving unit 170 to drive the mobile part 150 and the movable part 110.

Next, please refer to FIG. 4. FIG. 4 is a rear perspective view of the optical element driving mechanism 1, according to certain features of the present disclosure. For illustrative purposes, the outer frame 153 of the mobile part 150 and the movable part main body 111 of the movable part 110 are not combined, and the first frame 120 is shown in dashed lines.

After the outer frame 153 of the mobile part 150 is combined with the movable part main body 111 of the movable part 110, the connecting element 112 of the movable part 110 movably connects the mobile part 150 and the movable part 110. In this embodiment, the connecting elements 112 are four spheres. When the driving assembly 130 drives the movable part main body 111 to move, the connecting elements 112 roll between the outer frame 153 and the movable part main body 111 so that the movable part main body 111 moves smoothly relative to the outer frame 153.

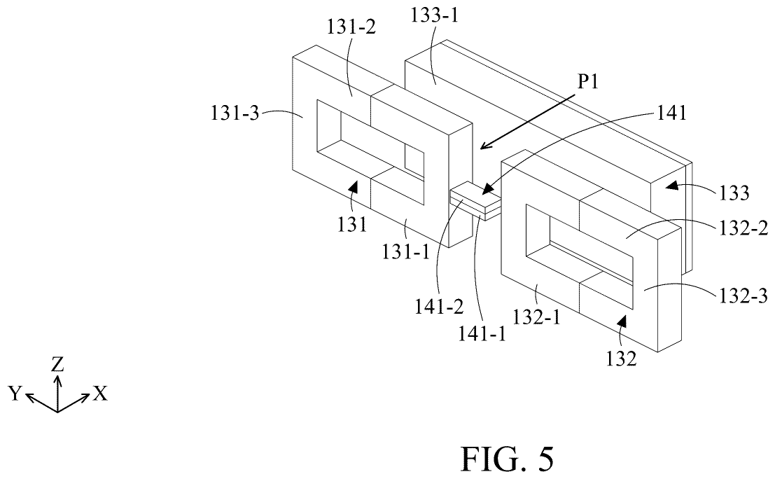

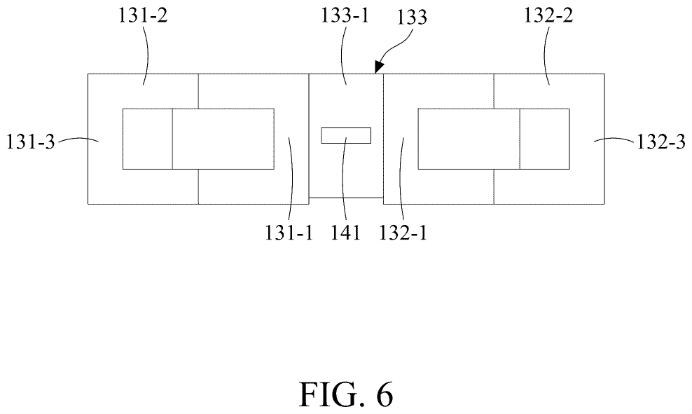

Next, please refer to FIG. 5 and FIG. 6 together. FIG. 5 is a rear perspective view of the driving assembly 130 and the first sensing element 141 of the first sensing assembly 140, according to certain features of the present disclosure. FIG. 6 is a rear view of the driving assembly 130 and the first sensing element 141 of the first sensing assembly 140, according to certain features of the present disclosure.

In this embodiment, the first coil 131 and the second coil 132 are fixed to the first frame 120, and the magnetic element 133 is fixed to the movable part 110.

The first coil 131 corresponds to the magnetic element 133 and has a first section 131-1, a second section 131-2 and a third section 131-3. The first section 131-1 is connected to the third section 131-3 via the second section 131-2. The first section 131-1 and the second section 131-2 are not parallel. The third section 131-3 is not parallel to the second section 131-2.

The second coil 132 corresponds to the magnetic element 133 and has a fourth section 132-1, a fifth section 132-2 and a sixth section 132-3. The fourth section 132-1 is connected to the sixth section 132-3 via the fifth section 132-2. The fourth section 132-1 and the fifth section 132-2 are not parallel. The sixth section 132-3 and the fifth section 132-2 are not parallel.

The magnetic element 133 is fixed to the movable part main body 111 of the movable part 110 (not shown in FIG. 5 and FIG. 6). The magnetic element 133 has a magnetic element surface 133-1 facing the first section 131-1 (the first section 131-1 overlaps the magnetic element surface 133-1 in the X direction). A magnetic pole arrangement direction P1 of the magnetic element 133 passes through the magnetic element surface 133-1.

Please see FIG. 6. When viewed along the direction perpendicular to the magnetic element surface 133-1, the magnetic element surface 133-1 does not overlap with the third section 131-3, and the magnetic element surface 133-1 is not completely covered by the second section 131-2.

The first sensing element 141 of the first sensing assembly 140 is disposed between the first coil 131 and the second coil 132. The first sensing element 141 corresponds to the magnetic element 133. The first sensing element 141 includes a reference part 141-1 and a magnetized part 141-2. The reference part 141-1 has a fixed magnetic field direction. The magnetized part 141-2 may change the direction of the magnetic field according to the direction of the surrounding magnetic field.

Next, please refer to FIG. 7 to FIG. 10 together.

FIG. 7 is a rear perspective view of the optical element driving mechanism 1, according to certain features of the present disclosure, in which the movable part 110 is located in a default position. For illustrative purposes, the upper cover 151 and the first frame 120 are shown in dashed lines.

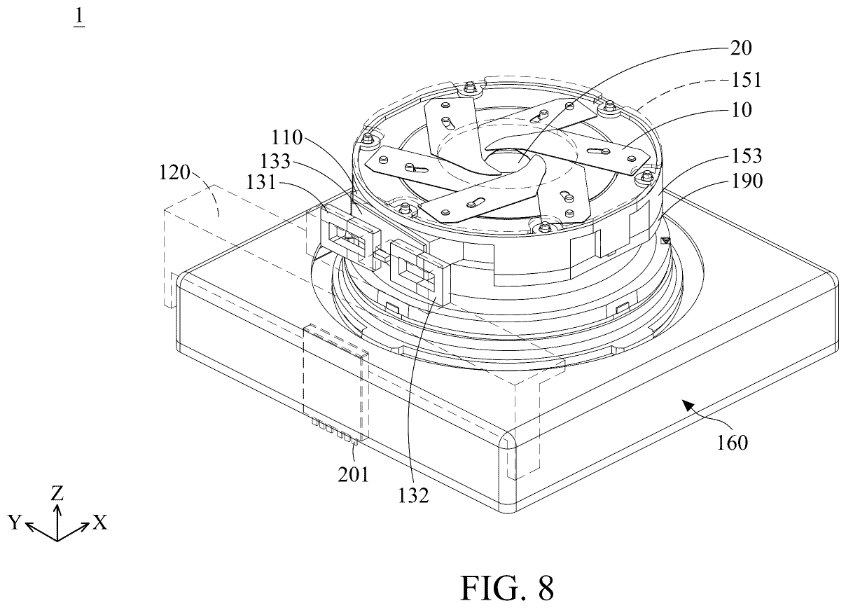

FIG. 8 is a rear perspective view of the optical element driving mechanism 1, according to certain features of the present disclosure, in which the movable part 110 is located in a first extreme position. For illustrative purposes, the upper cover 151 and the first frame 120 are shown in dashed lines.

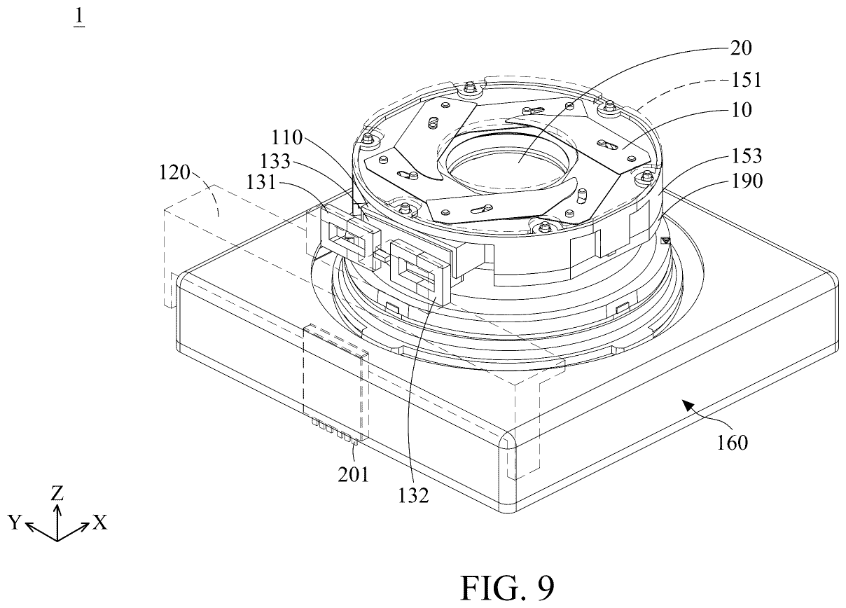

FIG. 9 is a rear perspective view of the optical element driving mechanism 1, according to certain features of the present disclosure, in which the movable part 110 is located in a second extreme position. For illustrative purposes, the upper cover 151 and the first frame 120 are shown in dashed lines.

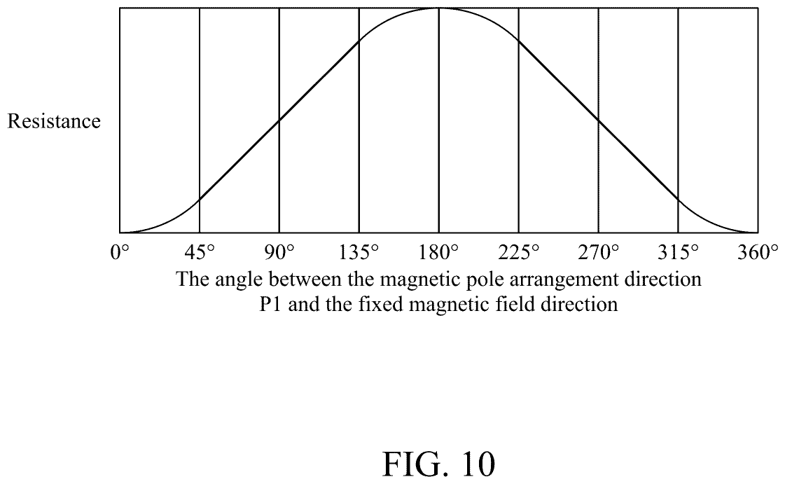

FIG. 10 is a diagram illustrating the relationship between the change in angle between the magnetic pole arrangement direction P1 of the magnetic element 133 and the fixed magnetic field direction of the reference part 141-1 of the sensing element 141 and the resistance, according to certain features of the present disclosure.

The driving assembly 130 is for driving the movable part 110 to move relative to the first frame 120 in a first dimension D1. In detail, through the electromagnetic driving force generated by the first coil 131 and the second coil 132 of the driving assembly 130 and the magnetic element 133, the magnetic element 133 drives the movable part 110 to move in the first dimension D1 relative to the first frame 120. The movement of the movable part 110 drives the movement of the optical element 10, thereby adjusting the aperture size composed of the optical element 10.

The movable part 110 may move within a movable part movement range relative to the first frame 120. The movable part movement range is defined by a first extreme position (i.e., the position shown in FIG. 8) and a second extreme position (i.e., the position shown in FIG. 9). In the first extreme position shown in FIG. 8, the aperture formed by the optical element 10 is the smallest, and the minimum amount of incident light is achieved. In the second extreme position shown in FIG. 9, the aperture formed by the optical element 10 is the largest, and the maximum amount of incident light is achieved.

A movable part default position (the position in FIG. 7) is defined within the movable part movement range. In this embodiment, the movable part default position is located in the middle of three equal parts of the movable part movement range. That is, the movable part default position (the position in FIG. 7) is located in the middle part of the three equal parts of the range between the first extreme position (the position in FIG. 8) and the second extreme position (the position in FIG. 9).

Next, please refer to FIG. 10. The relationship between the change in angle between the magnetic pole arrangement direction P1 of the magnetic element 133 and the fixed magnetic field direction of the reference part 141-1 of the sensing element 141 and the resistance may be seen from FIG. 10.

When the angle between the magnetic pole arrangement direction P1 and the fixed magnetic field direction is 0 degrees, the magnetic field direction of the magnetized part 141-2 of the first sensing element 141 is parallel to the fixed magnetic field direction of the reference part 141-1. At this time, the first sensing element 141 experiences no resistance. When the angle between the magnetic pole arrangement direction P1 and the direction of the fixed magnetic field continues to increase, the resistance experienced by the first sensing element 141 also increases. When the angle between the magnetic pole arrangement direction P1 and the fixed magnetic field direction is 45 degrees, the magnetic field direction of the magnetized part 141-2 of the first sensing element 141 is affected by the magnetic pole arrangement direction P1 of the magnetic element 133. The magnetic field direction of the magnetized part 141-2 of the first sensing element 141 is 45 degrees from the direction of the fixed magnetic field of the reference part 141-1. At this time, the first sensing element 141 experiences some resistance. When the angle between the magnetic pole arrangement direction P1 and the fixed magnetic field direction is 180 degrees, the magnetic field direction of the magnetized part 141-2 of the first sensing element 141 is affected by the magnetic pole arrangement direction P1 of the magnetic element 133. The magnetic field direction of the magnetized part 141-2 of the first sensing element 141 is 180 degrees from the direction of the fixed magnetic field of the reference part 141-1. At this time, the first sensing element 141 experiences the greatest resistance.

When the angle between the magnetic pole arrangement direction P1 and the direction of the fixed magnetic field continues to increase after 180 degrees, the resistance experienced by the first sensing element 141 begins to decrease. When the angle between the magnetic pole arrangement direction P1 and the fixed magnetic field direction is 225 degrees, the magnetic field direction of the magnetized part 141-2 of the first sensing element 141 is affected by the magnetic pole arrangement direction P1 of the magnetic element 133. The magnetic field direction of the magnetized part 141-2 of the first sensing element 141 is 225 degrees from the direction of the fixed magnetic field of the reference part 141-1. At this time, the first sensing element 141 experiences less resistance than when it is 180 degrees. When the angle between the magnetic pole arrangement direction P1 and the direction of the fixed magnetic field continues to increase, the resistance experienced by the first sensing element 141 continues to decrease. When the angle between the magnetic pole arrangement direction P1 and the fixed magnetic field direction is 360 degrees, the magnetic field direction of the magnetized part 141-2 of the first sensing element 141 is parallel to the fixed magnetic field direction of the reference part 141-1. At this time, the first sensing Element 141 experiences no resistance.

Please refer to the resistance curve in FIG. 10. The angle between the magnetic pole arrangement direction P1 of the magnetic element 133 and the direction of the fixed magnetic field is a line ranging from 0 degrees to 180 degrees. Observing the resistance curves as the angles vary from 0 degrees to 180 degrees, the resistance curves with the angles from 0 degrees to 45 degrees and from 135 degrees to 180 degrees are nonlinear. The resistance curves with angles from 45 degrees to 135 degrees (marked with bold lines) is approximately linear.

When the first sensing element 141 senses the magnetic element 133, the linear resistance line makes the sensing and estimation data more accurate. Therefore, the angle between the magnetic pole arrangement direction P1 of the magnetic element 133 and the direction of the fixed magnetic field is preferably 45 degrees to 135 degrees.

In this embodiment, in order to optimize the accuracy of the sensing element 141, when the movable part 110 is located in any position within the movable part movement range, the angle between the magnetic pole arrangement direction P1 and the fixed magnetic field direction of the reference part 141-1 is neither 0 degrees nor 180 degrees.

That is, when the movable part 110 is in the first extreme position (the position shown in FIG. 8), the angle between the magnetic pole arrangement direction P1 and the fixed magnetic field direction of the reference part 141-1 is neither 0 degrees nor 180 degrees. When the movable part 110 is located in the second extreme position (the position shown in FIG. 9), the angle between the magnetic pole arrangement direction P1 and the fixed magnetic field direction of the reference part 141-1 is neither 0 degrees nor 180 degrees.

When the movable part 110 is located in the movable part default position (the position shown in FIG. 7), the angle between the magnetic pole arrangement direction P1 and the fixed magnetic field direction of the reference part 141-1 is between 60 degrees and 120 degrees. That is since the movable part default position is located in the middle part of three equal parts of the movable part movement range. When the movable part 110 is located in the movable part default position, the angle between the magnetic pole arrangement direction P1 and the fixed magnetic field direction of the reference part 141-1 is 90 degrees.

Next, please refer to FIG. 11 to FIG. 13 together.

FIG. 11 is a rear perspective view of the optical element driving mechanism 1, according to certain features of the present disclosure, in which the mobile part 150 is located in a default position. For illustrative purposes, the optical element 10 and the outer frame 153, the upper cover 151, the first frame 120 are removed, and the bottom case 163 is shown in dashed lines.

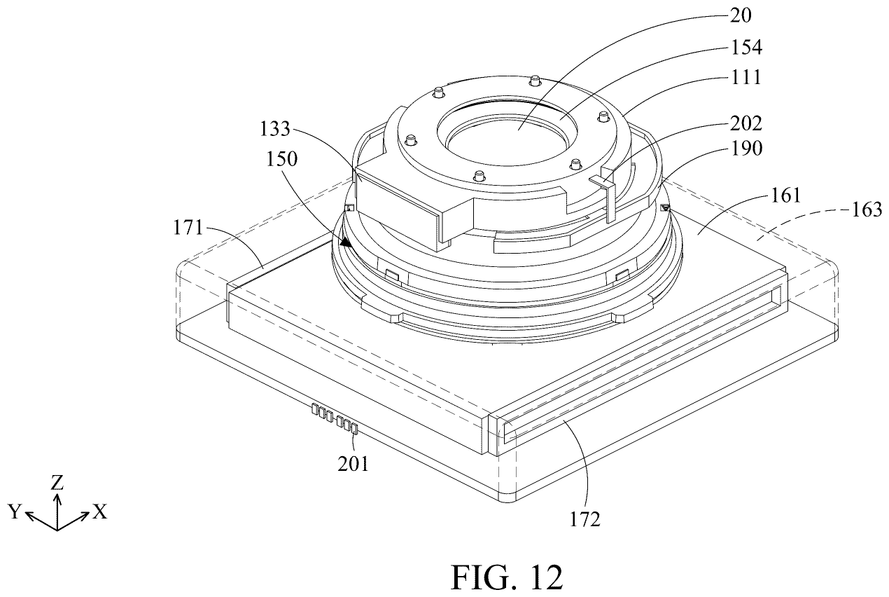

FIG. 12 is a rear perspective view of the optical element driving mechanism 1, according to certain features of the present disclosure, in which the mobile part 150 is located in a first calibration position. For illustrative purposes, the optical element 10 and the outer frame 153, the upper cover 151, the first frame 120 are removed, and the bottom case 163 is shown in dashed lines.

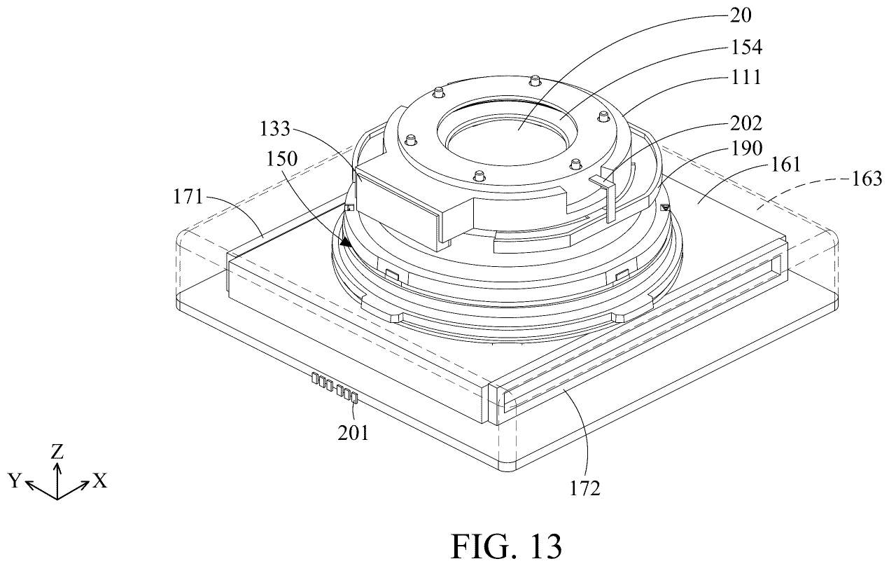

FIG. 13 is a rear perspective view of the optical element driving mechanism 1, according to certain features of the present disclosure, in which the mobile part 150 is located in a second calibration position. For illustrative purposes, the optical element 10 and the outer frame 153, the upper cover 151, the first frame 120 are removed, and the bottom case 163 is shown in dashed lines.

The driving unit 170 is for driving the movable part 110 (not shown), the mobile part 150, and the second frame 190 to move relative to the fixed part 160 in a second dimension D2.

To be more specific, the movable part 110, the mobile part 150, and the second frame 190 are driven by the electromagnetic driving force generated by the coil 171 and the coil 172 and the magnetic unit (not shown) provided on the mobile part 150 of the driving unit 170. The movable part 110, the mobile part 150, and the second frame 190 move in the second dimension D2 relative to the fixed part 160. It further drives the movement of the optical unit 20, thereby adjusting the position of the optical unit 20 to adjust, for example, the focal length of a lens.

The mobile part default position (the position shown in FIG. 11) is different from the first calibration position (the position shown in FIG. 12). The mobile part default position is different from the second calibration position (the position shown in FIG. 13). The first calibration position and the second calibration position are different, and the mobile part default position is between the first calibration position and the second calibration position.

Next, please refer to FIG. 14. FIG. 14 is a block diagram of the control unit 200, the first database 210, the second database 220, and the third database 230 of the optical element driving mechanism 1, according to certain features of the present disclosure. The first database 210 is for recording the relationship between the position of the movable part 110 and a first sensing signal S1 output by the first sensing assembly 140. The second database 220 is for recording the relationship between the position of the mobile part 150 and a second sensing signal S2 output by the second sensing assembly 180. The third database 230 is for recording the relationship between the first database 210 and the second database 220.

When calibrating the optical element driving mechanism 1, the mobile part 150 is first fixed in the default position (the position shown in FIG. 11) and then the movable part 110 is rotated to obtain the first set of data and record it in the third database 230. Therefore, the third database 230 includes the relationship between a plurality of positions the movable part 110 is located in the movable part movement range when the mobile part 150 is located in the movable part default position and the first sensing signal S1. For example, the plurality of positions the movable part 110 is located in the movable part movement range may be the first extreme position shown in FIG. 8, the second extreme position shown in the FIG. 9, the movable part default position shown in FIG. 7, etc.

During the second stage of calibration of the optical element driving mechanism 1, the position of the mobile part 150 is changed and fixed, and then the movable part 110 is rotated again to obtain the second set of data and recorded in the third database 230. Therefore, the third database 230 includes the relationship between a plurality of positions the movable part 110 is located in the movable part movement range and the first sensing signal S1. For example, the plurality of positions the movable part 110 is located in the movable part movement range may be the first extreme position shown in FIG. 8, the second extreme position shown in the FIG. 9, the movable part default position shown in FIG. 7, etc.

During the third stage of calibration of the optical element driving mechanism 1, the position of the mobile part 150 is changed and fixed, and then the movable part 110 is rotated again to obtain the third set of data and recorded in the third database 230. Therefore, the third database 230 includes the relationship between a plurality of positions the movable part 110 is located in the movable part movement range and the first sensing signal S1. For example, the plurality of positions the movable part 110 is located in the movable part movement range may be the first extreme position shown in FIG. 8, the second extreme position shown in the FIG. 9, the movable part default position shown in FIG. 7, etc.

According to the first sensing signal S1, the second sensing signal S2 and the first database 210, the second database 220, and the third database 230, a control signal is output to the control unit 200 to drive the movable part 110.

In summary, the optical system of the embodiment of the present disclosure may drive the movable part to move smoothly relative to the fixed part, and may drive the movable part by the driving assembly to change the size of the aperture formed by the optical element. Thereby the amount of incident light may be adjusted. The driving unit drives the mobile part to change the position of the mobile part, thereby adjusting the lens focal length.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments may be made according to the disclosure herein, without departing from the spirit or scope of the disclosure. Thus, the breadth and scope of the present disclosure should not be limited by any of the above-described embodiments. Rather, the scope of the disclosure should be defined according to the following claims and their equivalents.

The terminology used herein is for the purpose of describing particular examples only and is not intended to be limiting of the disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”.

What is claimed is:

1. An optical element driving mechanism, comprising:
a movable part, connecting an optical element;
a first frame, wherein the movable part is moveable relative to the first frame;
a driving assembly, for driving the movable part to move relative to the first frame; and
a first sensing assembly, for sensing the movement of the movable part.

2. The optical element driving mechanism as claimed in claim 1, further comprising a second frame and an optical module, wherein the first frame is disposed on the optical module, and the optical module includes:
a mobile part connecting an optical unit;
a fixed part, wherein the mobile part is movable relative to the fixed part;
a driving unit, for driving the mobile part to move relative to the fixed part; and
a second sensing assembly, for sensing the movement of the mobile part;
wherein the second frame is fixedly connected to the mobile part.

3. The optical element driving mechanism as claimed in claim 2, wherein a part of the driving assembly is fixedly connected to the first frame; and
the first frame is fixedly connected to the fixed part, and the driving assembly and the driving unit are located on different sides of the fixed part.

4. The optical element driving mechanism as claimed in claim 2, wherein the driving assembly includes:
a first coil, having a first section, a second section, and a third section;
a magnetic element, having a magnetic element surface facing the first section, wherein a magnetic pole arrangement direction of the magnetic element passes through the magnetic element surface; and
a second coil, corresponding to the magnetic element, having a fourth section, a fifth section, and a sixth section;
wherein the first section is connected to the third section via the second section;
the first section and the second section are not parallel; and
the third section and the second section are not parallel;
the fourth section is connected to the sixth section via the fifth section;
the fourth section is not parallel to the fifth section; and
the sixth section is not parallel to the fifth section.

5. The optical element driving mechanism as claimed in claim 4, wherein when viewed along the direction perpendicular to the magnetic element surface:
the magnetic element surface does not overlap with the third section;
the magnetic element surface does not completely cover the second section.

6. The optical element driving mechanism as claimed in claim 4, wherein a first sensing element of the first sensing assembly is disposed between the first coil and the second coil, the first sensing element corresponds to the magnetic element, and the first sensing element includes:
a reference part, having a fixed magnetic field direction;
a magnetized part, may change the direction of the magnetic field according to the direction of the surrounding magnetic field.

7. The optical element driving mechanism as claimed in claim 6, wherein the driving assembly is for driving the movable part to move in a first dimension relative to the first frame; and
the driving unit is for driving the movable part and the mobile part to move in a second dimension relative to the fixed part.

8. The optical element driving mechanism as claimed in claim 6, wherein the movable part is movable within a movable part movement range relative to the first frame;
the movable part movement range is defined by a first extreme position and a second extreme position;
when the movable part is in the first extreme position, the angle between the magnetic pole arrangement direction and the fixed magnetic field direction is neither 0 degrees nor 180 degrees;
when the movable part is in the second extreme position, the angle between the magnetic pole arrangement direction and the fixed magnetic field direction is neither 0 degrees nor 180 degrees.

9. The optical element driving mechanism as claimed in claim 8, wherein when the movable part is located in any position within the movable part movement range, the angle between the magnetic pole arrangement direction and the direction of the fixed magnetic field is neither 0 degrees nor 180 degrees.

10. The optical element driving mechanism as claimed in claim 8, wherein a movable part default position is defined within the movable part movement range, and the movable part default position of is located in the middle of three equal parts of the movable part movement range.

11. The optical element driving mechanism as claimed in claim 10, wherein when the movable part is in the movable part default position, the angle between the magnetic pole arrangement direction and the direction of the fixed magnetic field is between 60 degrees and 120 degrees.

12. The optical element driving mechanism as claimed in claim 10, wherein when the movable part is in the movable part default position, the angle between the magnetic pole arrangement direction and the direction of the fixed magnetic field is 90 degrees.

13. The optical element driving mechanism as claimed in claim 10, further comprising:
a first database, for recording the relationship between the position of the movable part and a first sensing signal output by the first sensing assembly;
a second database, for recording the relationship between the position of the movable part and a second sensing signal output by the second sensing assembly; and
a third database, for recording the relationship between the first database and the second database.

14. The optical element driving mechanism as claimed in claim 13, wherein the third database includes the relationship between a plurality of positions of the movable part within the movable part movement range and the first sensing signal when the mobile part is in a mobile part default position.

15. The optical element driving mechanism as claimed in claim 14, wherein the third database includes the relationship between a plurality of positions of the movable part within the movable part movement range and the first sensing signal when the mobile part is in a first calibration position.

16. The optical element driving mechanism as claimed in claim 14, wherein the movable part default position is different from the first calibration position.

17. The optical element driving mechanism as claimed in claim 14, wherein the third database includes the relationship between a plurality of positions of the movable part within the movable part movement range and the first sensing signal when the mobile part is in a second calibration position.

18. The optical element driving mechanism as claimed in claim 17, wherein the mobile part default position is different from the second calibration position.

19. The optical element driving mechanism as claimed in claim 17, wherein the first calibration position and the second calibration position are different, and the mobile part default position is between the first calibration position and the second calibration position.

20. The optical element driving mechanism as claimed in claim 13, further comprising a control unit, outputting a control signal based on the first sensing signal, the second sensing signal and the first database, the second database, and the third database to drive the movable part.
